(19) United States
(12) Patent Application Publication
(10) Pub. No.: US 2014/0136139 A1
(43) Pub. Date: May 15, 2014

(54) OPTICAL FIBER ANALYSIS DEVICE, SYSTEM, AND METHOD

(71) Applicants: Chris LaBonge, Quakertown, PA (US); Tom Depaolantonio, Birmingham, AL (US)

(72) Inventors: Chris LaBonge, Quakertown, PA (US); Tom Depaolantonio, Birmingham, AL (US)

(21) Appl. No.: 14/075,670

(22) Filed: Nov. 8, 2013

Related U.S. Application Data
(60) Provisional application No. 61/724,667, filed on Nov. 9, 2012.

(51) Int. Cl. G01M 11/00

(52) U.S. Cl. CPC G01M 11/30
USPC 702/122; 702/108

(57) ABSTRACT

An optical fiber analysis device, comprises at least one computer processor, computer memory and wireless network interface. The device also comprises a computer program stored in the computer memory and executable by the at least one processors to: receive and utilize optical fiber field test equipment results, associate the results with newly identified or already known test results, logical connection data, and/or geographical location data, and store the results and their associations in a central object database with similar historic data for the purpose of assessing the integrity of the individual optical fiber segments, the overall level of performance of the individual optical fiber segments, and any change in performance of the individual optical fiber segments over time.

### CROSS-REFERENCE TO RELATED APPLICATIONS

This application claims the benefit, under 35 U.S.C §119, to U.S. Provisional Patent Application No. 61/724,667, filed on Nov. 9, 2012, in the United States Patent and Trademark Office, the disclosure of which is incorporated herein in its entirety by reference.

### FIELD OF INTEREST

The present inventive concepts relate to the field of fiber optic test and measurement equipment and processes, and to equipment, systems and methods for testing, measuring, inspection and storing such data for optical fiber segments.

### BACKGROUND

The use of fiber optics is ever-increasing. For example, fiber optics is an increasing part of the communications infrastructure used within communities, regions and beyond. When installed, the integrity of the fiber optic path must be tested to ensure appropriate signal strength and quality of service (QoS). The process for testing fiber optic paths or links involves testing in the field, i.e., at the location of the installed fiber.

Regarding the fiber process of acquiring data either real time and/or post processing, this is the process currently used in the field:
a. Fiber optic cable is concatenated together to another fiber optic cable by either using a fusion splice, mechanical splice or some type of fiber connector.
b. Once the cable is placed within the ground, conduit, aerial or a combination of those mentioned, the cable is visually inspected using an analog or digital video or handheld microscope.
c. Once the connector is inspected for defects and/or contamination, the results are reported in order to proceed with qualification/characterization of the fiber.
d. Qualification occurs using an optical power meter, laser/LED light source, visual fault locator, OTDR (optical time-domain reflectometer), ORL (optical return loss) or fault/break locator.
e. Characterization occurs using the products mentioned above in (d) with an addition of polarization mode dispersion, chromatic dispersion, spectral attenuation.
f. Once services has been rendered, then additional monitoring/testing can be completed using an Optical Spectrum Analyzer, OTDR, Channel Analyzer, Multi Wave Meter, SONET and Ethernet tester.
g. Technicians and/or Workgroups that fall within the following categories; Installation, Maintenance, Repair, Monitoring, Construction, or any groups interacting with a fiber plant, use a variety of the tests outlined above.
h. Once data is collected in the field it can then be post processed, (a process completed after data has been acquired), from the field device (via—USB cable, Flash drive, CDRW, RS232) to a stand-alone PC for viewing, manipulation and transmittal into a database.

### SUMMARY

In accordance with one aspect of the present disclosure, provided is a device, system, and method for the collection, association, storage, and retrieval of multiple characteristics of segments of installed optical fiber networks. Such characteristics include, but are not limited to, current and historic logical connection data, geographical location data, and field test results. The associations among the various sources and forms of data can be used to determine the integrity of installed optical fiber segments, the performance of the installed optical fiber segments at a given signal transmission rate, and the changes in the performance of the installed optical fiber segments over time. The process can be used to qualify the optical fiber segment to transmit signals at a specific rate.

In accordance with another aspect of the present disclosure, provided is a device, system, and method for the real-time testing of multiple characteristics of elements of fiber optic networks, association of the test results with the logical, physical, and geographical description of the element, display of the test results and their associated logical, physical, and/or geographical data, and storage/retrieval of the historical records of the test results and their associated logical, physical, and geographical data to/from a database. Such characteristics include, but are not limited to, those associated with Optical Time Domain Reflectometry (OTDR), Polarization Mode Dispersion, Chromatic Dispersion, Optical Return Loss, and Optical Spectrum. Essentially, the timely integration of optical fiber field testing and optical fiber test data management.

In accordance with another aspect of the present disclosure, provided is an optical fiber analysis device that includes at least one computer processor, computer memory, and wireless network interface. An optical fiber analysis computer program can be stored in the computer memory and can be executable by the at least one processor to receive optical fiber field test equipment results, associate the results with newly identified or already known test results, logical connection data, and/or geographical location data for the optical fiber segments or segments under test, and store the results and their associations in a central object database of the network asset management database (NAMD) with similar historic data for the purpose of assessing the integrity of the individual optical fiber segments, the overall level of performance of the individual optical fiber segments, and any change in performance of the individual optical fiber segments over time.

In some embodiments, a piece of optical fiber field test equipment can incorporate all or part of the computer program and/or central object database.

In some embodiments, all or part of the central object database can be remote to the computer device.

In some embodiments, a portable or mobile device can incorporate all or part of the computer program and/or the central object database.

In some embodiments, the portable or mobile device can be a mobile phone and the computer preprogram product can be an application on the mobile phone.

In some embodiments, the portable or mobile device can be a tablet and the computer preprogram product can be an application on the tablet.

In some embodiments, the portable or mobile device can be a laptop and the computer preprogram product can be an application on the laptop.

In accordance with another aspects of the present invention, provided is a computer program product, stored in a non-transitory media and executable by at least one processor of an optical fiber analysis device. The computer program product, when executed, causes the device to receive optical fiber field test equipment results, associate the results with newly identified or already known logical and/or geographical data; and store the results and their associations in a common database with similar historic data for the purpose of assessing the overall level of performance of the optical fiber and any change in performance thereof over time.

In some embodiments, the computer program product can be incorporated into an optical fiber field test equipment device.

In some embodiments, the computer program product can be incorporated into a portable or mobile device.

In accordance with another aspect of the present invention, provided is a computer program product, stored in a non-transitory media and executable by at least one processor of an optical fiber analysis device. The computer program product is executable to utilize optical fiber field test equipment results, associate the results with data from alternative test equipment, and store the results and their associations in a common database with similar historic data for the purpose of assessing the overall level of performance of the optical fiber and any change in performance thereof over time.

In some embodiments, the computer program product can be incorporated into an optical fiber field test equipment device.

In some embodiments, the computer program product can be incorporated into a portable or mobile device.

In some embodiments, the portable or mobile device can be a mobile phone and the computer preprogram product can be an application on the mobile phone.

In some embodiments, the portable or mobile device can be a tablet and the computer preprogram product can be an application on the tablet.

In some embodiments, the portable or mobile device can be a laptop and the computer preprogram product can be an application on the laptop.

In accordance with another aspect of the invention, provided is a mobile optical fiber analysis device, comprising: at least one processor, at least one computer storage device, and at least one wireless interface; a test equipment interface module configured to communicate with test and measurement equipment to receive test data for at least one optical fiber segment under test; a network asset management interface module configured to communicate with an external network asset management system having a database configured to store current and historical test results for the at least one optical fiber segment under test.

In various embodiments, the mobile optical fiber analysis device can comprise or be a tablet, a cellular phone, or a laptop computer.

In various embodiments, the mobile optical fiber analysis device can include the test and measurement equipment.

In various embodiments, the test and measurement equipment can be external to the mobile optical fiber analysis device, and the mobile optical fiber analysis device can be configured to wirelessly communicate with the external test and measurement equipment via a Bluetooth interface.

In various embodiments, the test and measurement equipment can be external to the mobile optical fiber analysis device, and the mobile optical fiber analysis device can be configured to wirelessly communicate with the external test and measurement equipment via at least one of a cellular or satellite network.

In various embodiments, the network asset management system can be remote and communicate with the mobile optical fiber analysis device via the at least one wireless interface.

In various embodiments, the network asset management database can comprise historical data for the at least one optical fiber segment and the network asset management interface module can be configured to associate current test results with the historical data and to output performance of the at least one optical fiber relative to the historical data.

In various embodiments, the network asset management database can be a central common object database.

In various embodiments, the device can further comprise a test, measurement, and analysis module configured to generate test results from the test data.

In various embodiments, the test, measurement, and analysis module can be configured to analyze the test results to assess integrity of the at least one optical fiber under test.

In accordance with another aspect of the invention, provided is a mobile optical fiber system, comprising: a remote network asset management system having a database configured to store current and historical test results for optical fiber segments; test and measurement equipment configured to perform field tests of at least one optical fiber segment; and a mobile optical fiber analysis device configured to receive current test data from the test and measurement equipment and to communicate the current test data to the network asset management system.

In various embodiments, the mobile optical fiber analysis device can comprise: at least one processor, at least one computer storage device, and at least one wireless interface; a test equipment interface module configured to communicate with the test and measurement equipment to receive the test data for at least one optical fiber segment under test; and a network asset management interface module configured to communicate with the network asset management system.

In various embodiments, the mobile optical fiber analysis device can be or comprise a tablet, a cellular phone, or a laptop computer.

In various embodiments, the mobile optical fiber analysis device can include at least some of the test and measurement equipment.

In various embodiments, the test and measurement equipment can be external to the mobile optical fiber analysis device, and the mobile optical fiber analysis device can be configured to wirelessly communicate with the external test and measurement equipment via a Bluetooth interface.

In various embodiments, the test and measurement equipment can be external to the mobile optical fiber analysis device, and the mobile optical fiber analysis device can be configured to wirelessly communicate with the external test and measurement equipment via at least one of a cellular or satellite network.

In various embodiments, the network asset management system can be remote and can be configured to communicate with the mobile optical fiber analysis device via the at least one wireless interface.

In various embodiments, the network asset management database can comprise historical data for the at least one optical fiber segment and the network asset management interface module can be configured to associate current test results with the historical data and to output performance of the at least one optical fiber relative to the historical data.

In various embodiments, the network asset management database can be a central common object database.

In various embodiments, the mobile optical fiber analysis device can further comprise a test, measurement, and analysis module configured to generate test results from the test data.

In various embodiments, the test, measurement, and analysis module can be configured to analyze the test results to assess integrity of the at least one optical fiber under test.

In accordance with another aspect of the invention, provided is a method of optical fiber analysis, comprising: providing an optical fiber analysis device including at least one processor, at least one computer storage device, and at least one wireless interface; wirelessly receiving test data for at least one optical fiber under test by the optical fiber analysis device from in-field test and measurement equipment by the optical fiber analysis device; and electronically communicating the test data from the optical fiber analysis device to a remote network asset management system by the optical fiber analysis device.

In various embodiments, the method can further comprise the network asset management system storing and analyzing the test data, generating a test report, and electronically communicating the test report to the optical fiber analysis device.

In various embodiments, communication between the optical fiber analysis device and the network asset management system can include wireless communication.

In various embodiments, communication between the optical fiber analysis device and the test and measurement equipment can include real-time wireless communication.

In various embodiments, the method can further comprise associating historical data from the network asset management system with the test data received by the optical fiber analysis device, and assessing a performance of the at least one optical fiber relative to the historical data based on the associating of the historical data with the test data.

In various embodiments, the method can further comprise assessing an integrity of the at least one optical fiber based on the test data and outputting the integrity assessment.

In various embodiments, the mobile optical fiber analysis device can be or comprise a tablet, a cellular phone, or a laptop computer.

In various embodiments, the test and measurement equipment can be internal to the mobile optical fiber analysis device.

In accordance with another aspect of the invention, provided is a computer program product stored in a memory of a mobile optical fiber analysis device and executable by at least one processor thereof to perform a method of optical fiber analysis, comprising: wirelessly receiving test data for at least one optical fiber under test by the optical fiber analysis device from in-field test and measurement equipment by the optical fiber analysis device; and electronically communicating the test data from the optical fiber analysis device to a remote network asset management system by the optical fiber analysis device.

In various embodiments, the method can further comprise associating historical data from the network asset management system with the test data received by the optical fiber analysis device, and assessing a performance of the at least one optical fiber relative to the historical data based on the associating of the historical data with the test data.

In various embodiments, the method can further comprise assessing an integrity of the at least one optical fiber based on the test data and outputting the integrity assessment.

In various embodiments, the mobile optical fiber analysis device can be or comprise a tablet, a cellular phone, or a laptop computer.

In various embodiments, the test and measurement equipment can be internal to the mobile optical fiber analysis device.

In various embodiments herein, whether device, system, method, or computer program product, communication between and among various systems and devices can be in real-time or near real-time.

### BRIEF DESCRIPTION OF THE DRAWINGS

The present invention will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the invention. In the drawings:

FIG. 1 is a representative block diagram showing how an optical fiber analysis device can be used as an interface to multiple fiber optic test and measurement devices, in accordance with aspects of the present invention;

FIG. 2A is a block diagram of an optical fiber analysis system, in accordance with aspects of the present invention;

FIG. 2B is another block diagram of an optical fiber analysis system, in accordance with aspects of the present invention;

FIG. 3 is a block diagram of an optical fiber analysis device configured to interface with an optical fiber analysis system and test and measurement equipment for an optical path, segment, and/or network, in accordance with aspects of the present invention;

FIG. 4 is a block diagram depicting a communication flow of an optical fiber analysis system, in accordance with aspects of the present invention;

FIG. 5A depicts an example of an existing method 500 of data acquisition, documentation and retrieval in an optical fiber test and measurement environment;

FIG. 5B depicts an example of an improved method of data acquisition, documentation and retrieval in an optical fiber test and measurement environment, in accordance with aspects of the present invention;

FIG. 6 is a block diagram illustrating interactions between the optical fiber analysis device and other components of the optical fiber analysis system, in accordance with aspects of the present invention; and

FIG. 7 provides a schematic view of an optical fiber analysis device, in accordance with aspects of the present invention.

### DETAILED DESCRIPTION OF PREFERRED EMBODIMENTS

Various exemplary embodiments will be described more fully hereinafter with reference to the accompanying drawings, in which some exemplary embodiments are shown. The present inventive concept may, however, be embodied in many different forms and should not be construed as limited to the exemplary embodiments set forth herein.

It will be understood that, although the terms first, second, etc. are be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular fauns “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

To the extent that functional features, operations, and/or steps are described herein, or otherwise understood to be included within various embodiments of the inventive concept, such functional features, operations, and/or steps can be embodied in functional blocks, units, modules, operations and/or methods. And to the extent that such functional blocks, units, modules, operations and/or methods include computer program code, such computer program code can be stored in a computer readable medium, e.g., such as non-transitory memory and media, that is executable by at least one computer processor.

In accordance with aspects of the present invention, provided is optical fiber analysis device. In some embodiments, the present invention can take the form of an existing tool used across all the markets for test and measurement, inspection, and splicing that is then uniquely configured or altered to include a computer program product (or “App”) that would preferably be otherwise transparent to the technician performing its typical tasks.

The optical fiber analysis device could be configured to utilize its existing screen and interfaces and a unique application “App” that is executable to eliminate the need for the technician to use the screen and software within the various platforms and test sets. Hence, the technician would only need to use the optical fiber analysis device to drive the various testing platforms while viewing, manipulating, storing and updating databases, via email, Bluetooth, or WiFi type of communication link, as examples. The operator would, therefore, save a significant amount of time in collecting and analyzing data, which could lead to more rapidly taking maintenance and/or repair actions.

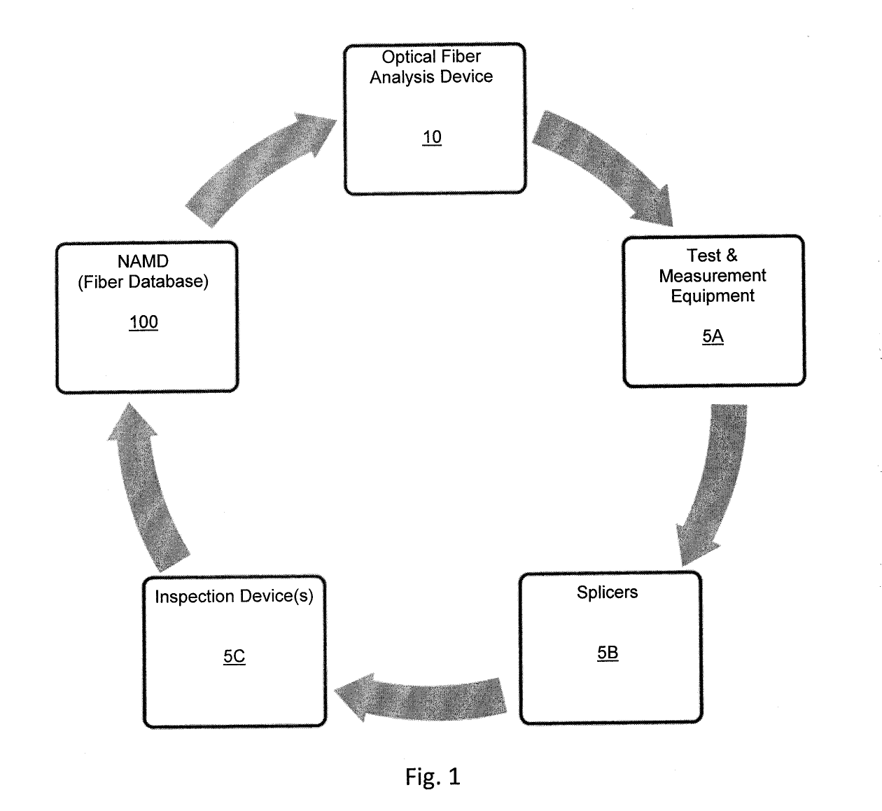

FIG. 1 is a representative block diagram showing how an optical fiber analysis device can be used as an interface to multiple fiber optic test and measurement devices, in accordance with aspects of the present invention. FIG. 1 provides an embodiment of an optical fiber analysis device cycle. An optical fiber analysis device 10 could be configured to automatically update a network asset management system/database (NAMD), or fiber database. 100 with the inspection results from the various connectors within the link/system that is currently being evaluated/tested/qualified/characterized/monitored/repaired/constructed, etc. The NAMD's 100 fiber database could be a central database or database systems (or “cloud-based” database) with which one or more optical fiber analysis devices 10 could wirelessly communicate. For example, the optical fiber analysis device 10 could communicate with test & measurement devices 5A, splicer 5B, and inspection devices 5C, which could all directly or indirectly communicate with the NAMD's 100 fiber database.

The optical fiber analysis device 10 could provide a common thread/link between all inspections, test and processing of data, as well as it could be utilized across all markets and work groups within the end user. Various formats and a wide variety of extensions are used within the test and measurement world. A common OTDR file format that is an industry standard would be a (.sor) file format, as an example. This format allows vendors to have “inter-operability” hence, have the ability to view other manufacturers OTDR traces without their 3^{rd} party software.

In accordance with aspects of the present invention, also provided is a method for analyzing optical fiber cables, paths, segments and/or networks (generally referred to as “optical fiber segments”) using the optical fiber analysis device 10. In various embodiments, a method of optical fiber analysis may include use of the optical fiber analysis device 10, e.g., as a specially configured commercially available platform (e.g., Apple, Google, MS or IOS platform(s)), to: 1. view; 2. test; and 3. transfer optical fiber test and measurement data (in real-time and/or during post processing), wherein the optical fiber analysis device 10 can be the driving (or controlling) component. The optical fiber analysis device 10 can include Bluetooth, WiFi and LCD screen (or touch screen) capabilities and components, to name a few examples.

The fiber optic test and measurement equipment market has equipment, i.e., splicers, analog/digital microscope, optical power meters, optical laser sources, back reflection meters, fault/break locators, OTDR's (Non-Coherent, Coherent, OFDR, CWDR and normal OTDR functionality), dispersion test sets, monitoring equipment, SONET, Gig E (1, 10, 40 and 100) Ethernet that use a box (single point solution or modular) that has some type of LCD viewer to construct, test, maintain and troubleshoot the fiber optic networks. The fiber optic networks can be existing and/or currently under construction.

Once the fiber optic networks are created and/or installed, there is a process of obtaining the network data based on the integrity of the fiber and it's connectivity. This data must be written into a type of data depository (e.g., fiber database 100) and can be called upon to actively monitor and maintain/repair the network over time. In some embodiments, the data can be archived and used across all utility/telecom companies, due to the common GIS locations through GPS coordinates, i.e., longitude, latitude, time, and so on.

In accordance with the present invention, optical fiber analysis device 10—e.g., a properly configured Apple, Google, MS or IOS platform, can be the active component to drive/view the test equipment, relay the information to additional optical fiber analysis devices for viewing and/or manipulation, as well as to forward the information for archive storage into a remote database (e.g., at NAMD 100). Examples of different types of databases that the optical fiber analysis device 10 can be configured to interface with could include CAD, AutoCAD, ArcCad, Load Data, Arc Info, Oracle, OSP Insight, MapInfo, to name a few.

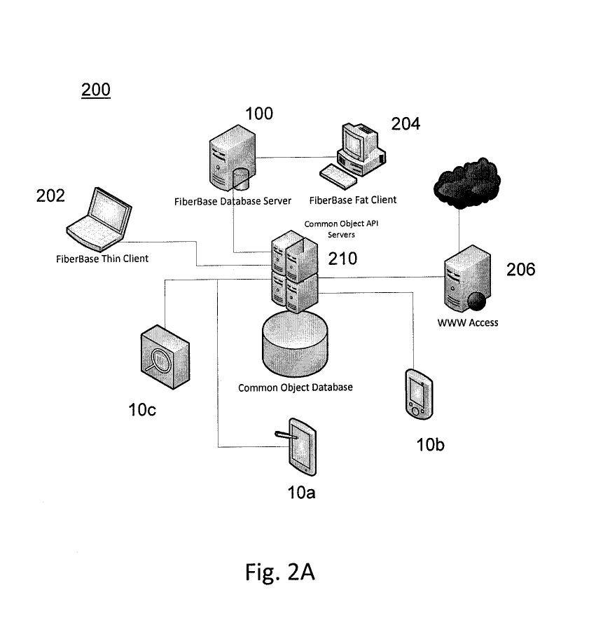

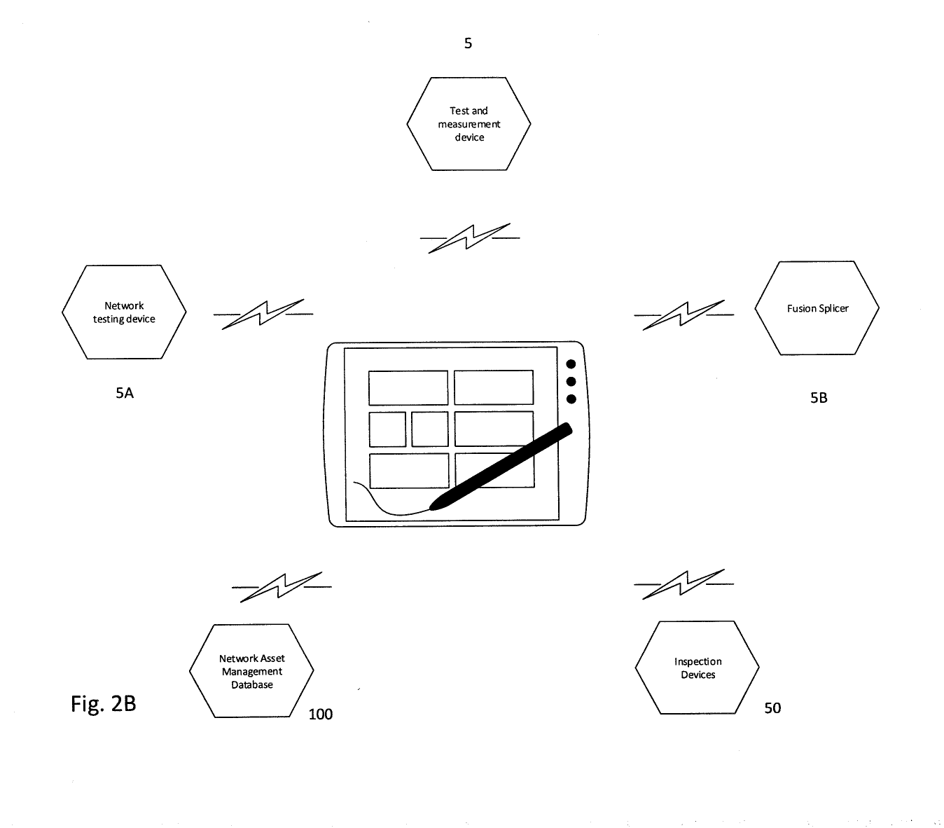

Referring to FIG. 2A, provided is an embodiment of an optical fiber analysis system 200 in accordance with aspects of the present invention. In this embodiment, there is provided a central object data server 210, where objects may be stored and retrieved from any number of thin and fat clients 202, 204. Objects can be shared among multiple institutions (collectively 206), if so desired, or kept private. Objects may share relationships, or be autonomous for more complex objects. Complex objects may have conversion methods that allow them to be exported in an application specific format, or optionally in an industry standard format.

Intermediate servers may bridge current legacy environments with the Common Object Server. Newer technologies may be directly supported with no bridging necessary.

To support various vendor interfaces, a new common object file format that can mirror the flexibility of the NAMD's 100 fiber database can be provided. Vendors can adopt the new file format as a temporary vehicle for importing or exporting objects into the Common Object Server 210. Because of the universal aspects of the file format, vendors may also use it to share data between themselves, without requiring an object server.

As discussed above, an optical fiber analysis device 10a, 10b, and/or 10c can be part of or interface with the optical fiber analysis system 200. The optical fiber analysis device 10a, 10b, and/or 10c can be portable or mobile devices, where a computer program product can be an application on the mobile phone (or other computer) that implements the functionality of the optical fiber analysis device 10a, 10b, and/or 10c. In such embodiments, the optical fiber analysis device platform can be a mobile phone, a tablet, or a laptop computer, as examples, executing or hosting the optical fiber analysis device computer program product.

FIG. 2B is another block diagram of an optical fiber analysis system, in accordance with aspects of the present invention. In this diagram, the optical fiber analysis device 10 is at the center and its potential communications are shown, similar to FIG. 1. The NAMD's 100 fiber database can be configured to be accessible by one or more optical fiber analysis devices 10, e.g., by wireless communications. For example, the optical fiber analysis device 10 could communicate with test & measurement devices 5A, splicer 5B, and inspection devices 5C, which could all directly or indirectly communicate with the NAMD 100. As a result, the optical fiber analysis devices 10 can be considered an NAMD communication device, which bridges a communication gap between field equipment and the NAMD, in real or near-real time, very quickly and efficiently.

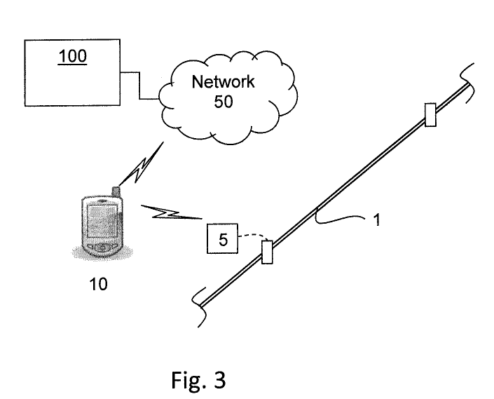

FIG. 3 is a block diagram of an optical fiber analysis device 10 configured to interface with an NAMD 100 (as in FIG. 2A) and test and measurement (T&M) equipment 5 for an optical path, segment, and/or network 1, in accordance with aspects of the present invention. In this embodiment, the T&M equipment is applied to the fiber for performance of test, measurement, and analysis of the fiber segment 1. T&M equipment 5 is controlled and/or monitored by the optical fiber analysis device 10, through wireless communication. The T&M data can be communicated to a remote database (e.g., fiber database 100), as part of the optical fiber analysis system 200, via a network 50 (e.g., Internet), which can comprise various wired or wireless segments or communication paths. As such, new data for the optical segment 1 can be stored and processed in any number of advantageous manners, e.g., comparing new data to old data to see if there has been a degradation in the optical segment.

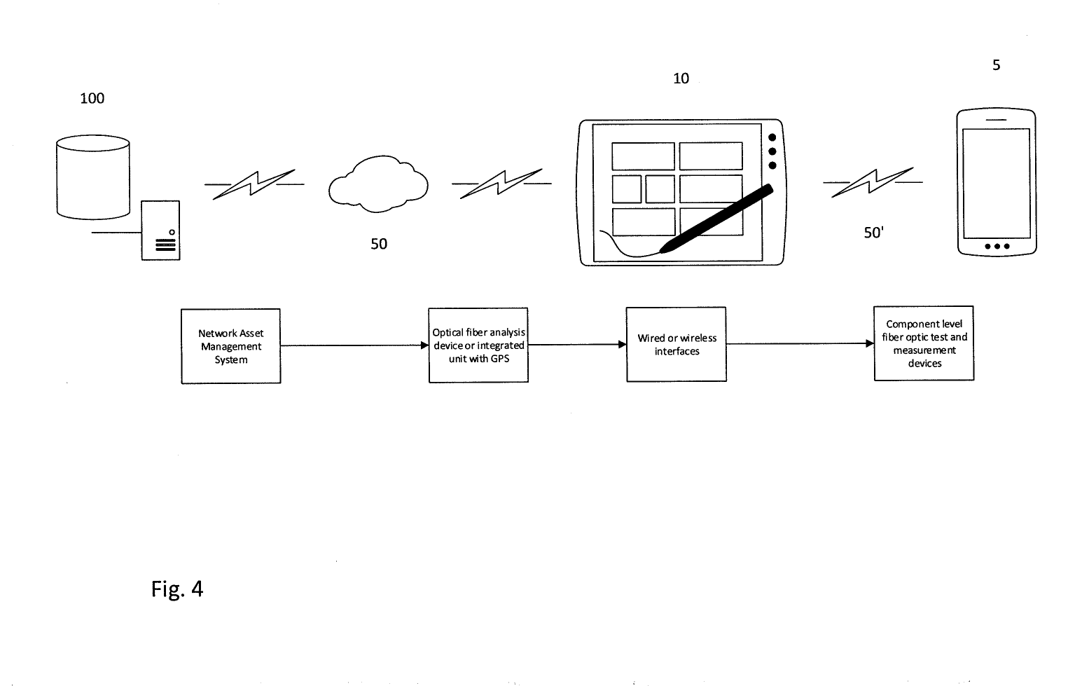

FIG. 4 is a block diagram depicting a communication flow of an optical fiber analysis system 200, which includes the optical fiber analysis device 10 (e.g., a tablet). In this embodiment, the optical fiber analysis device 10 can communicate with the network asset management database (NAMD) 100 (or fiber database) via a wired and/or wireless network 50. The optical fiber analysis device 10 can also communicate with component-level optical test and measurement equipment 5 (e.g., OTDR, video inspection device, ORL meter, optical power meter, etc.), also via a wired and/or wireless network 50′.

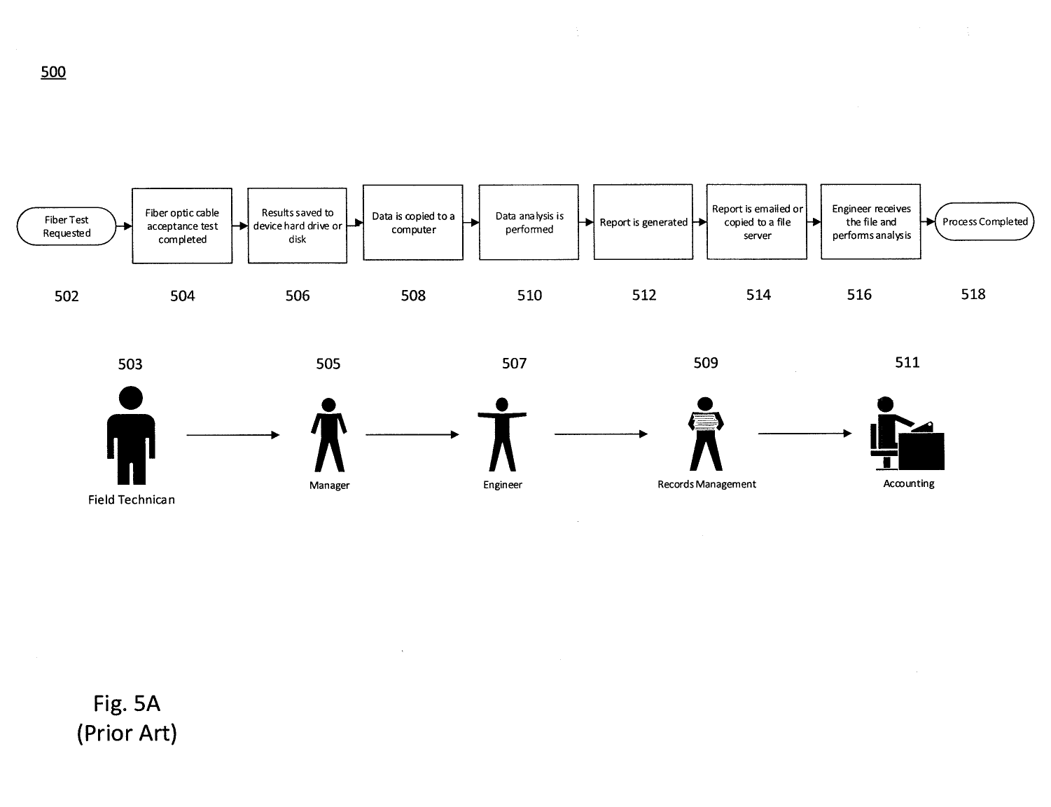

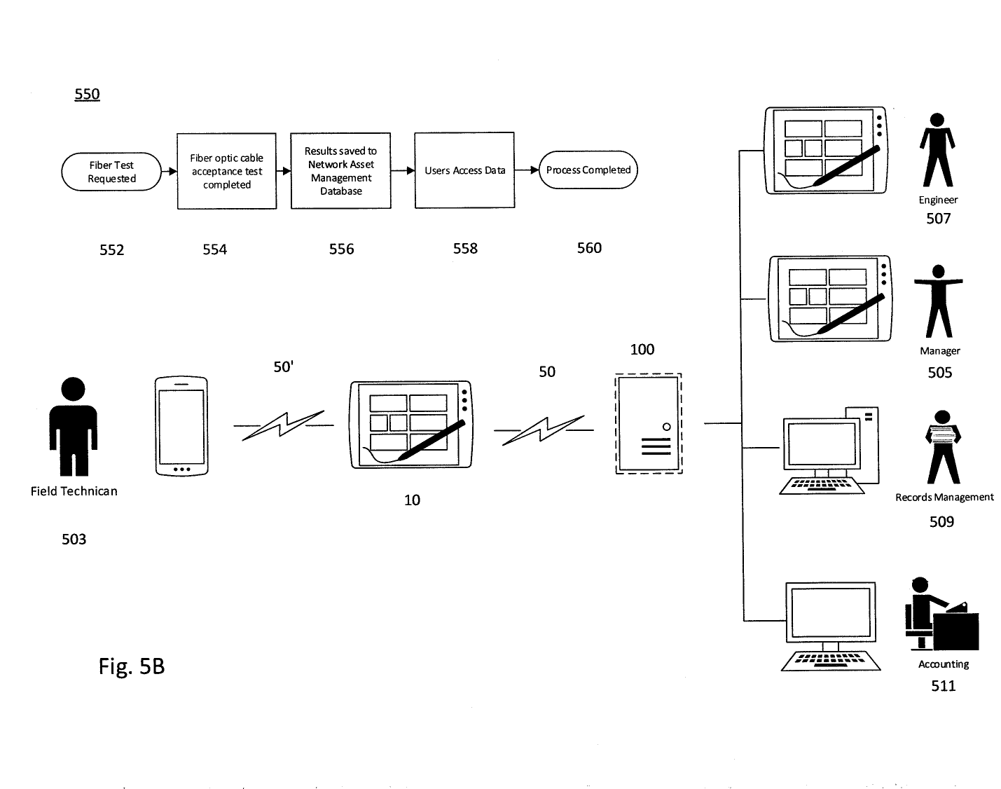

FIG. 5A depicts an example of an existing method 500 of data acquisition, documentation and retrieval in an optical fiber test and measurement environment. Basically, a field technician gathers test, measurement and analysis data in the field, saves it to an NAMD (or the like) and an engineer subsequently analyzes the data by accessing the NAMD to generate a report (or some other kind of output). Thereafter, other users may access the NAMD and engineer output, such as a manager, records management department, and/or accounting department.

In step 502, a fiber test is requested, e.g., by a field technician 503. In step 504, a fiber optic cable acceptance test is completed, e.g., by the field technician 503. In step 506, the results of the acceptance test are saved to a local storage device of the test equipment, e.g., hard drive or memory chip. In step 508, the results are copied to a laptop or desktop personal computer. In step 510, a data analysis is performed. In step 512, a test report is generated. In step 514, the report is uploaded or copied to a file server (e.g., fiber database 100). In step 516, the report is downloaded for analysis by an engineer 507, which conducts engineering analysis and generates an engineering report or other output. And in step 518, the process is completed.

A manager 505, records management department 509, and/or accounting department 511 could then access the post processed test data, report and engineer output for various purposes.

FIG. 5B depicts an example of an improved method 550 of data acquisition, documentation and retrieval in an optical fiber test and measurement environment. In step 552, a field technician 503 requests a fiber test. In step 554, a fiber optic cable acceptance test is completed by the field engineer 503 using test and measurement equipment 5. An optical fiber analysis device 10 receives the test data and causes the results to be saved to the NAMD 100, or fiber database, via a wired and/or wireless network 50, in step 556. The optical fiber analysis device 10 may be with the field technician (in the field) and communicate the test results to a remote NAMD 100 over any one or more of a variety of networks (cell, satellite etc.). Or the NAMD could generate the test result and communicate them back to the optical fiber analysis device 10. In step 558, users, such as a manager 505, an engineer 507, a record management department 509, or accounting department 511, as examples, that is/are remote or local to the NAMD can access the test results, e.g., over a wired or wireless network. In some embodiments, the optical fiber analysis device 10 could also forward test results and/or data to such users.

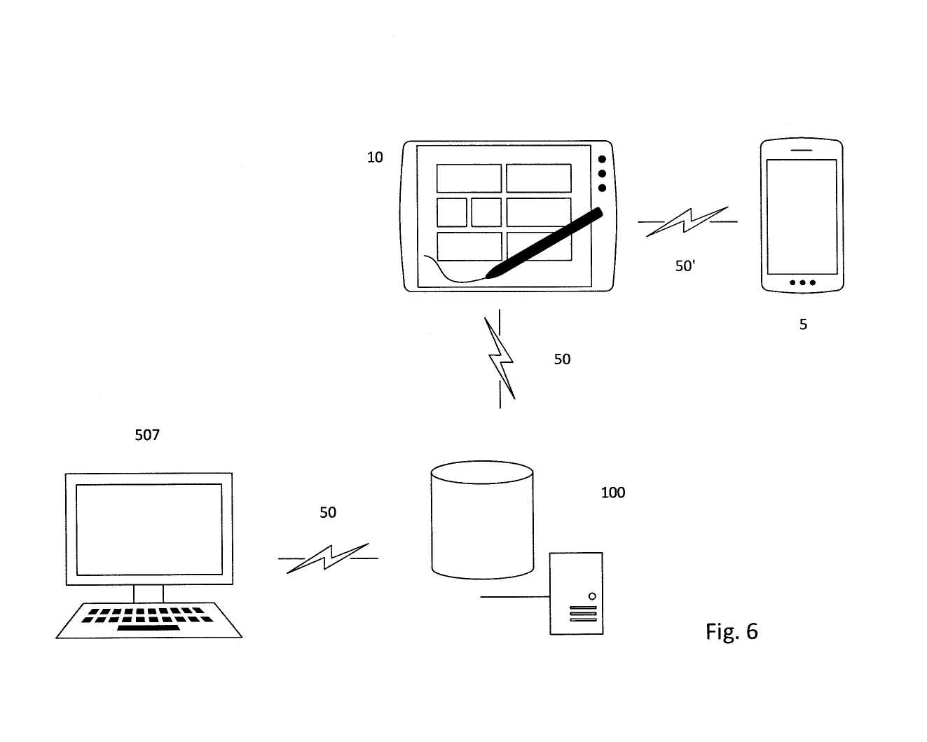

FIG. 6 is a block diagram illustrating interactions between the optical fiber analysis device 10 and other components of the optical fiber analysis system 200. The optical fiber analysis device 10 can communicate with one or more fiber optic test and measurement device 5 in the field, e.g., through a wireless network 50′. That is, the connection between the optical fiber analysis device 10 and fiber optic test and measurement device 5 can be wired or wireless (e.g., Bluetooth, WiFi, cell, satellite, etc.). The optical fiber analysis device 10 communicates with the NAMD (or fiber database) 100, to receive data from the test and measurement device(s) 5, which can be in real-time (or near real-time) and which can be done via a wide area network 50 (e.g., the Internet, cellular, or satellite), for example. Data, in raw, preprocessed or post-processed form, can be served from the NAMD 100 to remote engineers (computers) 507, having access to the NAMD 100. For instance, such data can be served to the remote engineers while the technician is still on-site (in the field). As a result, an efficient electronic propagation of fiber optic test result data can occur from the test and measurement equipment in the field to the remote engineer. In some embodiments, the optical fiber analysis device 10 can communicate directly with the remote engineer 507, and not through the NAMD 100—or communicate to both in parallel.

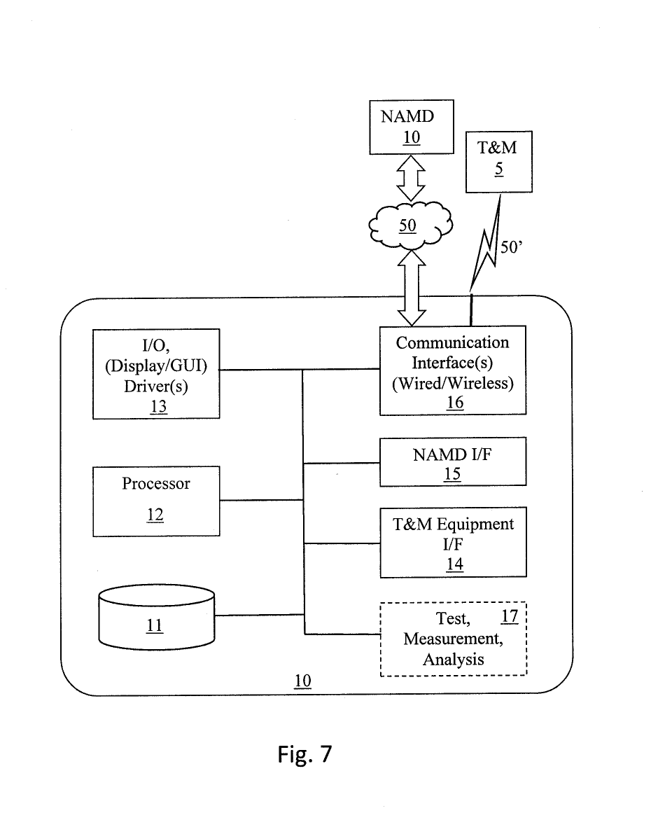

FIG. 7 provides a schematic view of an optical fiber analysis device 10, in accordance with aspects of the present invention. The optical fiber analysis device 10 can include at least one processor (or microprocessor) 12, e.g., CPU, ALU and so on), which executes various functions of the optical fiber analysis device 10. The processor(s) 12 can be configured to execute computer program code stored in a data storage device 11, which can also be used to store data and test, measurement, and analysis results. The data storage device 11 can be or include a hard drive, various forms of random access memory (RAM), various forms of read only memory (ROM), or other presently known or hereafter developed data storage media. Input and output (I/O) drivers can be included to support user interaction with typical user interface mechanisms, including, but not limited to, a graphical user interface (GUI) (e.g., touchscreen), keyboard, mouse, audio inputs and outputs, light emitting diodes, switches, button, dials, and so on.

The optical fiber analysis device 10 can also include a test and measurement (T&M) equipment interface (I/F) module 14, which can be used to communicate with in-the-field test, measurement and/or analysis equipment 5, such as those mentioned herein. The optical fiber analysis device 10 can include an NAMD interface module 15, which can be used to communicate with a remote NAMD system 100, such as discussed herein. One or more communication interface modules 16, supporting or enabling wired or wireless communications, can also be included and used by the T&M Equipment I/F module 14 and NAMD I/F module 15 to communicate with their respective external entities and systems, e.g., via a network 50 or local wireless link 50′.

The optical fiber analysis device 10 can, optionally, include test, measurement and analysis functionality or modules 17, such as for controlling, interpreting, monitoring, and/or analyzing information and data from the T&M equipment 5 or NAMD 100. The test, measurement and analysis functionality or modules 17 can also be configured to processes test data and generate test reports, which could be communicated to the NAMD, or other systems or devices (e.g., via email, text message, RSS feed, or posting to a browser based site or other application.

Therefore, the optical fiber analysis device 10 can includes at least one computer processor, computer memory, and wireless network interface. An optical fiber analysis computer program can be stored in the computer memory and can be executable by the at least one processor to receive and utilize optical fiber field test equipment 5 results; associate the results with newly identified or already known test results, logical connection data, and/or geographical location data for the optical fiber segments or segments under test; and store the results and their associations in a central object database of the NAMD 100 with similar historic data for the purpose of assessing the integrity of the individual optical fiber segments, the overall level of performance of the individual optical fiber segments, and any change in performance of the individual optical fiber segments over time.

While the foregoing has described what are considered to be the best mode and/or other preferred embodiments, it is understood that various modifications can be made therein and that the invention or inventions may be implemented in various forms and embodiments, and that they may be applied in numerous applications, only some of which have been described herein. It is intended by the following claims to claim that which is literally described and all equivalents thereto, including all modifications and variations that fall within the scope of each claim.

What is claimed is:

1. A mobile optical fiber analysis device, comprising:
at least one processor, at least one computer storage device, and at least one wireless interface;
a test equipment interface module configured to communicate with test and measurement equipment to receive test data for at least one optical fiber segment under test;
a network asset management interface module configured to communicate with an external network asset management system having a database configured to store current and historical test results for the at least one optical fiber segment under test.

2. The device of claim 1, wherein the mobile optical fiber analysis device comprises a tablet, a cellular phone, or a laptop computer.

3. The device of claim 1, wherein the mobile optical fiber analysis device includes the test and measurement equipment.

4. The device of claim 1, wherein the test and measurement equipment is external to the mobile optical fiber analysis device, and the mobile optical fiber analysis device is configured to wirelessly communicate with the external test and measurement equipment via a Bluetooth interface.

5. The device of claim 1, wherein the test and measurement equipment is external to the mobile optical fiber analysis device, and the mobile optical fiber analysis device is configured to wirelessly communicate with the external test and measurement equipment via at least one of a cellular or satellite network.

6. The device of claim 1, wherein the network asset management system is remote and communicates with the mobile optical fiber analysis device via the at least one wireless interface.

7. The device of claim 1, wherein the network asset management database comprises historical data for the at least one optical fiber segment and the network asset management interface module is configured to associate current test results with the historical data and to output performance of the at least one optical fiber relative to the historical data.

8. The device of claim 1, wherein the network asset management database is a central common object database.

9. The device of claim 1, further comprising:
a test, measurement, and analysis module configured to generate test results from the test data.

10. The device of claim 9, wherein the test, measurement, and analysis module is configured to analyze the test results to assess integrity of the at least one optical fiber under test.

11. A mobile optical fiber system, comprising:
a remote network asset management system having a database configured to store current and historical test results for optical fiber segments;
test and measurement equipment configured to perform field tests of at least one optical fiber segment; and
a mobile optical fiber analysis device configured to receive current test data from the test and measurement equipment and to communicate the current test data to the network asset management system.

12. The system of claim 11, wherein the mobile optical fiber analysis device comprises:
at least one processor, at least one computer storage device, and at least one wireless interface;
a test equipment interface module configured to communicate with the test and measurement equipment to receive the test data for at least one optical fiber segment under test; and
a network asset management interface module configured to communicate with the network asset management system.

13. The system of claim 11, wherein the mobile optical fiber analysis device comprises a tablet, a cellular phone, or a laptop computer.

14. The system of claim 11, wherein the mobile optical fiber analysis device includes at least some of the test and measurement equipment.

15. The system of claim 11, wherein the test and measurement equipment is external to the mobile optical fiber analysis device, and the mobile optical fiber analysis device is configured to wirelessly communicate with the external test and measurement equipment via a Bluetooth interface.

16. The system of claim 11, wherein the test and measurement equipment is external to the mobile optical fiber analysis device, and the mobile optical fiber analysis device is configured to wirelessly communicate with the external test and measurement equipment via at least one of a cellular or satellite network.

17. The system of claim 11, wherein the network asset management system is remote and is configured to communicate with the mobile optical fiber analysis device via the at least one wireless interface.

18. The system of claim 11, wherein the network asset management database comprises historical data for the at least one optical fiber segment and the network asset management interface module is configured to associate current test results with the historical data and to output performance of the at least one optical fiber relative to the historical data.

19. The system of claim 11, wherein the network asset management database is a central common object database.

20. The system of claim 11, wherein the mobile optical fiber analysis device further comprises:
a test, measurement, and analysis module configured to generate test results from the test data.

21. The system of claim 20, wherein the test, measurement, and analysis module is configured to analyze the test results to assess integrity of the at least one optical fiber under test.

22. A method of optical fiber analysis, comprising:
providing an optical fiber analysis device including at least one processor, at least one computer storage device, and at least one wireless interface;
wirelessly receiving test data for at least one optical fiber under test by the optical fiber analysis device from in-field test and measurement equipment by the optical fiber analysis device; and
electronically communicating the test data from the optical fiber analysis device to a remote network asset management system by the optical fiber analysis device.

23. The method of claim 22, further comprising the network asset management system:
storing and analyzing the test data;
generating a test report; and
electronically communicating the test report to the optical fiber analysis device.

24. The method of claim 22, wherein communication between the optical fiber analysis device and the network asset management system includes wireless communication.

25. The method of claim 22, wherein communication between the optical fiber analysis device and the test and measurement equipment includes real-time wireless communication.

26. The method of claim 22, further comprising:
associating historical data from the network asset management system with the test data received by the optical fiber analysis device; and
assessing a performance of the at least one optical fiber relative to the historical data based on the associating of the historical data with the test data.

27. The method of claim 22, further comprising:
assessing an integrity of the at least one optical fiber based on the test data; and
outputting the integrity assessment.

28. The method of claim 22, wherein the mobile optical fiber analysis device comprises a tablet, a cellular phone, or a laptop computer.

29. The method of claim 22, wherein the test and measurement equipment is internal to the mobile optical fiber analysis device.

30. A computer program product stored in a memory of a mobile optical fiber analysis device and executable by at least one processor thereof to perform a method of optical fiber analysis, comprising:
wirelessly receiving test data for at least one optical fiber under test by the optical fiber analysis device from in-field test and measurement equipment by the optical fiber analysis device; and
electronically communicating the test data from the optical fiber analysis device to a remote network asset management system by the optical fiber analysis device.

31. The computer program product of claim 30, wherein the method further comprises:
associating historical data from the network asset management system with the test data received by the optical fiber analysis device; and
assessing a performance of the at least one optical fiber relative to the historical data based on the associating of the historical data with the test data.

32. The computer program product of claim 30, wherein the method further comprises:
assessing an integrity of the at least one optical fiber based on the test data; and
outputting the integrity assessment.

33. The computer program product of claim 30, wherein the mobile optical fiber analysis device comprises a tablet, a cellular phone, or a laptop computer.

34. The computer program product of claim 30, wherein the test and measurement equipment is internal to the mobile optical fiber analysis device.
